(19) United States
(12) Patent Application Publication
(10) Pub. No.: US 2009/0303173 A1
(43) Pub. Date: Dec. 10, 2009

(54) ELECTROPHORETIC DISPLAY APPARATUS AND ELECTRONIC APPARATUS

(75) Inventor: Kiichi KAJINO, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/430,493

(22) Filed: Apr. 27, 2009

(30) Foreign Application Priority Data
Jun. 9, 2008 (JP) 2008-150259

(51) Int. Cl. G09G 3/34; G09G 5/00

(52) U.S. Cl. 345/107; 345/214

(57) ABSTRACT

An electrophoretic display apparatus includes a display having a plurality of pixels each having a pixel electrode; and a common electrode opposed to the pixel electrode; an electrophoretic element disposed between the pixel electrode and the common electrode, the electrophoretic element containing electrophoretic particles; a driving unit that performs partial rewrite driving to partially rewrite an image displayed on the display by applying a drive voltage between the pixel electrode and the common electrode in part of the plurality of pixels on the basis of image data; a power supply circuit that increases power supply voltage and supplies the drive voltage to the driving unit; and a control unit that controls the power supply circuit so as to change the drive-voltage supply capacity of the power supply circuit in accordance with the area of a rewritten region that the part of the pixels occupies in the display.

### BACKGROUND

1. Technical Field

The present invention relates to the technical field of an electrophoretic display apparatus and an electronic apparatus equipped with the electrophoretic display apparatus.

2. Related Art

This type of electrophoretic display apparatus has a display that performs displays as follows with a plurality of pixels. In each of the pixels, an image signal is rewritten to a memory circuit via a pixel switching element, and thereafter, a pixel electrode is driven by a pixel potential according to the rewritten image signal to apply a voltage between it and a common electrode. This drives an electrophoretic element between the pixel electrode and the common electrode to perform display. This type of electrophoretic display apparatus sometimes adopts a driving method in which, if an image displayed on a display changes only partially when rewritten, the image is partially rewritten by applying a voltage between the pixel electrode and the common electrode of only pixels corresponding to the changed portion (hereinafter this driving method is referred to as “partial rewrite driving” as appropriate).

This type of electrophoretic display apparatus has a power supply circuit including a booster circuit constituted of, for example, a charging-pump type DC-DC converter (direct-current voltage converter), in which an electrophoretic element of the display is driven in each pixel by electricity supplied from the power supply circuit.

For example, JP-A-2007-244164 discloses a control circuit for a charging pump circuit in which, under low load, the charging pump circuit (i.e., a charging-pump type DC-DC converter) is operated at a low operation frequency, and under high load, the charging pump circuit is operated at a high operating frequency so that the power consumption of the charging pump circuit under low load is reduced while satisfying current capacity under high load.

When the above-described partial rewrite driving is adopted, the amount of electricity to be supplied by the power supply circuit to the display differs depending on the area of a portion of the display in which an image is rewritten (in other words, the number of pixels to which voltage is to be applied between the pixel electrode and the common electrode when partially writing the image). Therefore, it is considered that if the power supply circuit includes, for example, the charging-pump type DC-DC converter, a monitor circuit for monitoring the output voltage of the DC-DC converter is provided, and the operating frequency of the DC-DC converter is changed according to the output voltage to improve the power efficiency of the DC-DC converter, thereby reducing the power consumption. However, with such a monitor circuit, the monitor circuit itself consumes electricity; therefore, this has a technical problem in that the power efficiency of the entire power supply circuit including the DC-DC converter and the monitor circuit (or the entire electrophoretic display apparatus including this power supply circuit) is decreased. In particular, the power consumption of the display of the electrophoretic display apparatus is extremely low, a few microwatt; therefore, an increase in power consumption due to adding circuits, such as the above-described monitor circuit, to the power supply circuit of the electrophoretic display apparatus is a considerable problem.

### SUMMARY

An advantage of some aspects of the invention is to provide an electrophoretic display apparatus that adopts partial rewrite driving and is capable of displaying high-quality images while reducing power consumption and an electronic apparatus equipped with the electrophoretic display apparatus.

To solve the above problems, an electrophoretic display apparatus according to a first aspect of the invention includes a display including a plurality of pixels each having an electrophoretic element containing electrophoretic particles between a pixel electrode and a common electrode opposing each other; a driving unit that performs partial rewrite driving to partially rewrite an image displayed on the display by applying a drive voltage between the pixel electrode and the common electrode in part of the plurality of pixels on the basis of image data; a power supply circuit that increases power supply voltage and supplies the drive voltage to the driving unit; and a control unit that controls the power supply circuit so as to change the drive-voltage supply capacity of the power supply circuit in accordance with the area of a rewritten region that the part of the pixels occupies in the display.

With the electrophoretic display apparatus according to this aspect of the invention, in operation, a drive voltage is applied between the pixel electrode and the common electrode of each of the plurality of pixels on the basis of image data, so that the electrophoretic element provided between the pixel electrode and the common electrode is driven (that is, electrophoretic particles in the electrophoretic element move between the pixel electrode and the common electrode), and thus an image is displayed on the display. The driving unit is allowed to apply the drive voltage between the pixel electrode and the common electrode of each pixel when the drive voltage is supplied from the power supply circuit. The power supply circuit has a booster circuit, for example, a charging-pump type DC-DC converter, and increases a power supply voltage (for example, 3 V) from a power supply, such as a battery, to a drive voltage (for example, 12 V) and supplies it to the driving unit.

In this aspect, when rewriting an image displayed on the display, partial rewrite driving is performed by the driving unit. That is, when rewriting an image displayed on the display, if only part of the image changes, drive voltage is applied between the pixel electrode and the common electrode of pixels corresponding to the changed part (that is, part of the plurality of pixels), and no drive voltage is applied between the pixel electrode and the common electrode of pixels corresponding to unchanged part (that is, the other pixels except the part of the plurality of pixels). For example, the pixel electrodes of the pixels corresponding to the changed part are supplied with a pixel potential according to image data, and the pixel electrodes of the pixels corresponding to the unchanged part are supplied with the same potential as the common potential supplied to the common electrode. That is, since drive voltage is applied between the pixel electrode and the common electrode of only the pixels corresponding to the changed part of the plurality of pixels, the image portion displayed on the rewritten region that the part of the pixels occupies in the display is rewritten. Therefore, driving power, which is necessary for the driving unit to apply drive voltage between the pixel electrode and the common electrode, changes depending on the area of the rewritten region (in other words, the number of the pixels corresponding to the changed part).

In this aspect, in particular, the control unit controls the power supply circuit so as to change the drive-voltage supply capacity of the power supply circuit in accordance with the area of a rewritten region. For example, in the case where the power supply circuit includes the charging-pump type DC-DC converter, the control unit changes the operating frequency of the DC-DC converter in accordance with the area of the rewritten region. Typically, the control unit controls the power supply circuit so that the drive-voltage supply capacity of the power supply circuit is decreased as the area of the rewritten region decreases (in other words, the drive-voltage supply capacity of the power supply circuit is increased as the area of the rewritten region increases). In other words, the control unit controls the power supply circuit so that the power supply circuit has a drive-voltage supply capacity according to the area of the rewritten region. Here, the “drive-voltage supply capacity” means the capacity of the power supply circuit to supply drive voltage to the driving unit and can be translated to “driving-power supply capacity” to supply driving power necessary for the driving unit to apply drive voltage to each of the part of the pixels when performing partial rewrite driving.

Thus, the drive-voltage supply capacity of the power supply circuit changes depending on the area of the rewritten region. Therefore, the power consumed by the power supply circuit itself can be reduced more as compared with, for example, a case in which the drive-voltage supply capacity of the power supply circuit is constant at a drive-voltage supply capacity necessary when the area of the rewritten region is the maximum (that is, a drive-voltage supply capacity necessary for applying drive voltage between the pixel electrodes and the common electrode of all the pixels of the display) irrespective of the area of the rewritten region. Furthermore, the power supply circuit is controlled according to the area of the rewritten region. Therefore, the power consumed by the power supply circuit can be decreased more as compared with the configuration in which the power supply circuit includes the above-described monitor circuit. Accordingly, the power consumed when an image displayed on the display is rewritten can be reduced. In addition, drive voltage is supplied to the driving unit with a drive-voltage supply capacity according to the rewritten area. Therefore, drive voltage can be reliably applied between the pixel electrodes and the common electrode of the pixels to be rewritten. This allows a high-quality image to be displayed.

As described above, with the electrophoretic display apparatus according to the first aspect, the control unit controls the power supply circuit so as to change the drive-voltage supply capacity of the power supply circuit in accordance with the area of the rewritten area, thus allowing a high-quality image to be displayed while reducing power consumption.

It is preferable that the control unit control the power supply circuit so that the drive-voltage supply capacity is decreased as the area of the rewritten region decreases.

In this case, the power supply circuit is prevented from operating with unnecessarily high drive-voltage supply capacity, thereby reducing power consumed by the power supply circuit. In other words, a decrease in the power efficiency of the power supply circuit when the area of the rewritten region is small can be prevented.

It is preferable that the control unit include a calculating unit that calculates the area of the rewritten region on the basis of the image data.

In this case, the control unit can reliably control the power supply circuit in accordance with the area of the rewritten region calculated by the calculating unit on the basis of the image data.

It is preferable that the power supply circuit include an oscillator circuit that outputs a clock signal by performing an oscillating operation; and a booster circuit that increases the power supply voltage to the drive voltage by performing a charging pump operation according to the clock signal and that the control unit control the oscillator circuit so that the frequency of the clock signal is decreased as the area of the rewritten region decreases.

In this case, the drive-voltage supply capacity of the power supply circuit can be changed relatively easily by the control unit in accordance with the area of the rewritten region.

To solve the above problems, an electronic apparatus according to a second aspect of the invention includes the above-described electrophoretic display apparatus according to the first aspect of the invention.

Since the electronic apparatus according to the second aspect of the invention is equipped with the electrophoretic display apparatus according to the first aspect, various electronic apparatuses in which power consumption can be reduced, such as wristwatches, electronic papers, electronic notebooks, mobile phones, and portable audio devices, can be achieved.

These and other operations and advantages of the invention will become more apparent upon reading of the following description of the preferred embodiments.

### BRIEF DESCRIPTION OF THE DRAWINGS

The invention will be described with reference to the accompanying drawings, wherein like numbers reference like elements.

FIG. 1 is a block diagram showing the overall configuration of an electrophoretic display apparatus according to an embodiment.

FIG. 2 is a circuit diagram showing the configuration of a DC-DC converter according to the embodiment.

FIG. 3 is an equivalent circuit diagram showing the electrical configuration of a pixel.

FIG. 4 is a fragmentary cross-sectional view of the display of the electrophoretic display apparatus according to the embodiment.

FIG. 5 is a schematic diagram showing the configuration of a microcapsule.

FIG. 6 is a plan view showing an example of images before and after rewriting.

FIG. 7 is a plan view showing images by conceptual region according to the gray scales before and after rewriting.

FIG. 8 is a flowchart showing a method for controlling a power supply circuit by a controller in this embodiment.

FIG. 9 is a perspective view showing the configuration of an electronic paper, which is an example of an electronic apparatus incorporating the electrophoretic display apparatus.

FIG. 10 is a perspective view showing the configuration of an electronic notebook, which is an example of an electronic apparatus incorporating the electrophoretic display apparatus.

### DESCRIPTION OF EXEMPLARY EMBODIMENTS

An embodiment of the invention will be described hereinbelow with reference to the drawings.

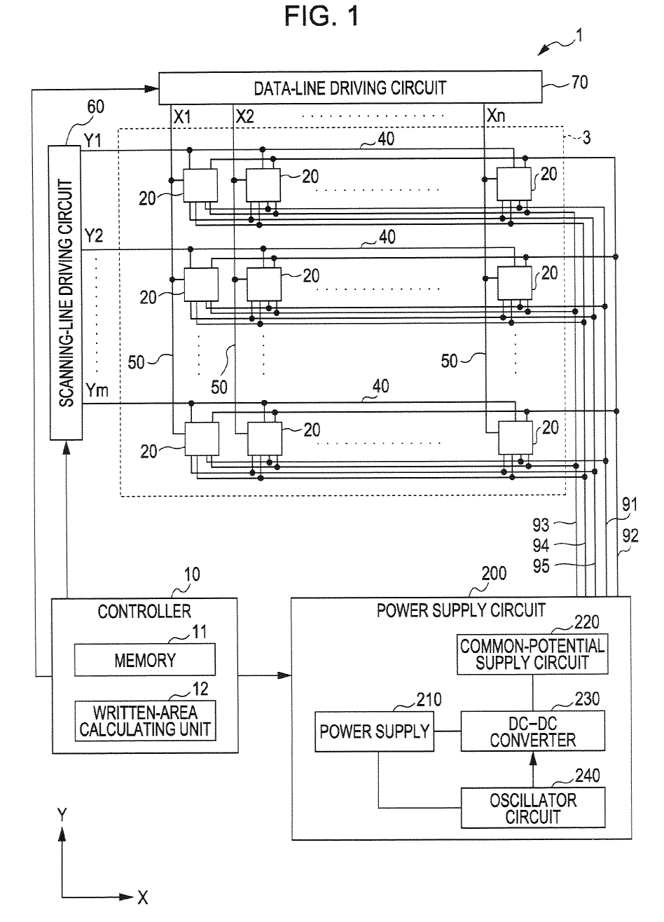

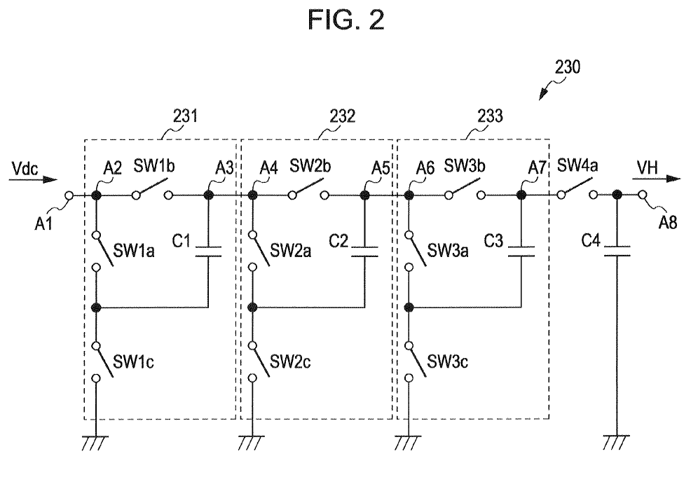

First, the overall configuration of an electrophoretic display apparatus according to this embodiment will be described with reference to FIGS. 1 and 2.

FIG. 1 is a block diagram showing the overall configuration of the electrophoretic display apparatus according to this embodiment.

In FIG. 1, the electrophoretic display apparatus 1 according to this embodiment includes a display 3, a scanning-line driving circuit 60, a data-line driving circuit 70, a controller 10, and a power supply circuit 200.

The display 3 has m×n pixels 20 arrayed in a matrix form (two-dimensional plane). The display 3 also has m scanning lines 40 (that is, scanning lines Y1, Y2, . . . , Ym) and, n data lines 50 (that is, data lines X1, X2, . . . , Xn) intersecting each other. Specifically, the m canning lines 40 extend in a row direction (that is, X direction), and the n data lines 50 extend in a column direction (that is, Y direction). Pixels 20 are disposed in correspondence with the intersections of the m scanning lines 40 and the n data lines 50.

The controller 10 controls the operations of the scanning-line driving circuit 60, the data-line driving circuit 70, and the power supply circuit 200. The controller 10 stores image data input from the exterior in a memory 11 and controls the operations of the various circuits on the basis of the image data. In this embodiment, in particular, the controller 10 includes a rewritten-area calculating unit 12 that calculates a rewritten area (that is, the area of a region to be rewritten). The rewritten-area calculating unit 12 will be described later.

The scanning-line driving circuit 60 supplies a pulsed scanning signal to each of the scanning lines Y1, Y2, . . . , Ym in sequence on the basis of a timing signal. The data-line driving circuit 70 supplies an image signal to the data lines X1, X2, . . . , Xn on the basis of a timing signal. The image signal has a binary level, that is, a high potential level (hereinafter referred to as “high level”, for example, 5 V) or a low potential level (hereinafter referred to as “low level”, for example, 0 V).

The power supply circuit 200 supplies a high-potential supply potential VEP to a high-potential power supply line 91, a low-potential supply potential Vss to a low-potential power line 92, a common potential Vcom to a common potential line 93, a first potential S1 to a first control line 94, and a second potential S2 to a second control line 95. Although not shown, the high-potential power supply line 91, the low-potential power line 92, the common potential line 93, the first control line 94, and the second control line 95 are each electrically connected to the power supply circuit 200 via an electrical switch. The pixels 20 are each electrically connected to the high-potential power supply line 91, the low-potential power line 92, the common potential line 93, the first control line 94, and the second control line 95. Typically shown in FIG. 1, the high-potential power supply line 91, the low-potential power line 92, the common potential line 93, the first control line 94, and the second control line 95 are wired in common to the pixels 20 that belong to each pixel array disposed along the row direction (X direction).

The power supply circuit 200 has a power supply 210, a common-potential supply circuit 220, a DC-DC converter 230, which is an example of “a booster circuit” according to an embodiment of the invention, and an oscillator circuit 240.

The power supply 210 is a primary battery or a secondary battery, which supplies electricity to the common-potential supply circuit 220, the DC-DC converter 230, and the oscillator circuit 240. The power supply 210 outputs a power supply voltage Vdc (for example, 3 V). In this embodiment, the power supply 210 supplies electricity only to the common-potential supply circuit 220, the DC-DC converter 230, and the oscillator circuit 240; however, it is not limited thereto and the power supply 210 may supply electricity to the other circuits, for example, the controller 10.

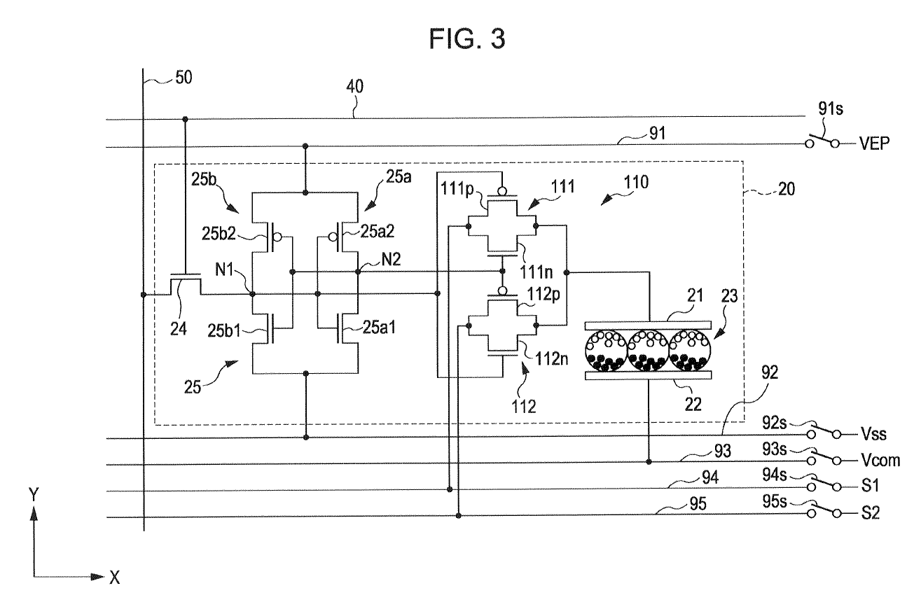

The common-potential supply circuit 220 is electrically connected to the common potential line 93 via a switch 93s (see FIG. 3) and outputs the common potential Vcom on the basis of a voltage applied from the DC-DC converter 230. In this embodiment, the common-potential supply circuit 220 is electrically connected to the first control line 94 via a switch 94s (see FIG. 3) and outputs the common potential Vcom as the first potential S1 to the first control line 94. The common potential line 93 and the first control line 94 constitute an example of “driving unit” according to an embodiment of the invention together with the high-potential power supply line 91, the low-potential power line 92, and the second control line 95 described below.

The DC-DC converter 230 is electrically connected to the high-potential power supply line 91 via a switch 91s (see FIG. 3) and generates a high potential VH (for example, 12 V) and outputs it as the high-potential supply potential VEP on the basis of the power supply voltage Vdc (for example, 3 V) applied from the power supply 210.

The oscillator circuit 240 is an oscillator circuit including, for example, a ring oscillator etc. and supplies a clock signal to the DC-DC converter 230. The oscillator circuit 240 is configured to be able to change the frequency of the clock signal output therefrom under the control of the controller 10.

The power supply circuit 200 has a grounding terminal (not shown) that is electrically connected to the ground into a low potential VL and outputs the low potential VL as the low-potential supply potential Vss from the grounding terminal to the low-potential power line 92.

In this embodiment, the second control line 95 is configured to be able to electrically connect to the DC-DC converter 230 and the above-mentioned ground potential via a switch 95s (see FIG. 3). The high potential VH output from the DC-DC converter 230 and the low potential VL output from the grounding terminal are switched and output as the second potential S2 to the second control line 95.

FIG. 2 is a circuit diagram showing the configuration of the DC-DC converter according to this embodiment.

In FIG. 2, the DC-DC converter 230 is a charging-pump type DC-DC converter and has unit circuits 231, 232, and 233, a switch SW4a, and a capacitor C4. The DC-DC converter 230 is configured to raise the power supply potential Vdc (for example, 3 V) input from the power supply 210 to a terminal Al that is the input terminal thereof and to output the high potential VH (for example, 12 V) from a terminal A8 that is the output terminal thereof.

The unit circuits 231, 232, and 233 are connected in series. That is, a terminal A3 that is the output terminal of the unit circuit 231 and a terminal A4 that is the input terminal of the unit circuit 232 are connected to each other, and a terminal A5 that is the output terminal of the unit circuit 232 and a terminal A6 that is the input terminal of the unit circuit 233 are connected to each other. A terminal A2 that is the input terminal of the unit circuit 231 is connected to the terminal Al and receives the power supply potential Vdc.

The unit circuit 231 includes three switches SW1a, SW1b, and SW1c and one capacitor C1. The switch SW1a and the switch SW1c are connected in series at one end. The other end of the switch SW1a is connected to the terminal A2 to which the power supply potential Vdc is input, and the other end of the switch SW1c is connected to the ground. The switch SW1b is connected between the terminal A2 and the terminal A3. The capacitor C1 is connected between the node of the switch SW1a and the switch SW1c and the terminal A3.

The unit circuit 232 has three switches SW2a, SW2b, and SW2c and one capacitor C2. The switch SW2a and the switch SW2c are connected at one end in series. The other end of the switch SW2a is connected to the terminal A4, and the other end of the switch SW2c is connected to the ground. The switch SW2b is connected between the terminal A4 and the terminal A5. The capacitor C2 is connected between the node of the switch SW2a and the switch SW2c and the terminal A5.

The unit circuit 233 has three switches SW3a, SW3b, and SW3c and one capacitor C3. The switch SW3a and the switch SW3c are connected at one end in series. The other end of the switch SW3a is connected to the terminal A6, and the other end of the switch SW3c is connected to the ground. The switch SW3b is connected between the terminal A6 and a terminal A7. The capacitor C3 is connected between the node of the switch SW3a and the switch SW3c and the terminal A7.

The switch SW4a is connected between the terminal A7 that is the output terminal of the unit circuit 233 and the terminal A8 that is the output terminal of the DC-DC converter 230. The capacitor C4 is what is called a smoothing capacitor, one end of which is connected between the switch SW4a and the terminal A8 that is the output terminal of the DC-DC converter 230, and the other end is connected to the ground.

Thus-configured DC-DC converter 230, in operation, raises the power supply potential Vdc (for example, 3 V) input to the terminal A1 to the high potential VH (for example, 12 V) by alternately switching the ON/OFF of a switch group consists of switches SW1a, SW2a, SW3a, and SW4a (hereinafter referred to as “first switch group”) and a switch group consists of switches SW1b, SW1c, SW2b, SW2c, SW3b, and SW3c (hereinafter referred to as “second switch group”) in response to a clock signal supplied from the oscillator circuit 240 and outputs it from the terminal A8 that is the output terminal.

That is, first, the first switch group is turned off, and the second switch group is turned on, so that the power supply voltage Vdc is applied to each of the capacitors C1, C2, and C3 to accumulate electric charge. Next, the first switch group is turned on, and the second switch group is turned off, so that the capacitors C1, C2, and C3 are connected in series between the terminal A2 and the terminal A7. Thus, the high potential VH that is the output potential of the DC-DC converter 230 increases by four times as high as the power supply potential Vdc that is the input potential thereof. In this embodiment, the DC-DC converter 230 is configured such that the output potential increases by four times as high as the power supply potential Vdc that is the input potential; however, it is not limited thereto and, for example, a unit circuit similar to the unit circuit 231 and so on may be provided, for example, between the terminal A7 and the switch Sw4a to increase the input potential by five times.

The DC-DC converter 230 is configured such that, when the first switch group is turned on and the second switch group is turned off, the electric charges accumulated in the capacitors C1, C2, and C3 move to output an output current Iout. Thus, the DC-DC converter 230 has power supply capacity to supply predetermined electric power, that is, a power of VH×Iout, to the display 3 of the electrophoretic display apparatus 1.

The maximum value of the output current Iout of the DC-DC converter 230 fluctuates depending on the operating speeds of the first switch group and the second switch group (that is, the speed at which ON and OFF are switched), that is, the frequency of the clock signal input from the oscillator circuit 240; when the frequency of the clock signal increases, the output current of the DC-DC converter 230 is increased (in other words, the power supply capacity of the DC-DC converter 230 is increased).

FIG. 3 is an equivalent circuit diagram showing the electrical configuration of the pixel.

In FIG. 3, the pixel 20 is provide with a pixel switching transistor 24, a memory circuit 25, a switch circuit 110, a pixel electrode 21, a common electrode 22, and an electrophoretic element 23.

The pixel switching transistor 24 is constituted of an N-type transistor, for example. The gate of the pixel switching transistor 24 is electrically connected to the scanning line 40, the source is electrically connected to the data line 50, and the drain is electrically connected to the input terminal N1 of the memory circuit 25. The pixel switching transistor 24 outputs an image signal supplied from the data-line driving circuit 70 (see FIG. 1) through the data line 50 to the input terminal N1 of the memory circuit 25 at a timing corresponding to a pulsed scanning signal supplied from the scanning-line driving circuit 60 (see FIG. 1) through the scanning line 40.

The memory circuit 25 includes inverter circuits 25a and 25b and is configured as a static random access memory (SRAM).

The inverter circuits 25a and 25b have a loop structure in which their individual input terminals are electrically connected to the other output terminals. That is, the input terminal of the inverter circuit 25a and the output terminal of the inverter circuit 25b are electrically connected to each other, and the input terminal of the inverter circuit 25b and the output terminal of the inverter circuit 25a are electrically connected to each other. The input terminal of the inverter circuit 25a is configured as the input terminal N1 of the memory circuit 25, and the output terminal of the inverter circuit 25a is configured as the output terminal N2 of the memory circuit 25.

The inverter circuit 25a includes an N-type transistor 25a1 and a P-type transistor 25a2. The gates of the N-type transistor 25a1 and the P-type transistor 25a2 are electrically connected to the input terminal N1 of the memory circuit 25. The source of the N-type transistor 25a1 is electrically connected to the low-potential power line 92 to which the low-potential supply potential Vss is supplied. The source of the P-type transistor 25a2 is electrically connected to the high-potential power supply line 91 to which the high-potential supply potential VEP is supplied. The drains of the N-type transistor 25a1 and the P-type transistor 25a2 are electrically connected to the output terminal N2 of the memory circuit 25.

The inverter circuit 25b includes an N-type transistor 25b1 and a P-type transistor 25b2. The gates of the N-type transistor 25b1 and the P-type transistor 25b2 are electrically connected to the output terminal N2 of the memory circuit 25. The source of the N-type transistor 25b1 is electrically connected to the low-potential power line 92 to which the low-potential supply potential Vss is supplied. The source of the P-type transistor 25b2 is electrically connected to the high-potential power supply line 91 to which the high-potential supply potential VEP is supplied. The drains of the N-type transistor 25b1 and the P-type transistor 25b2 are electrically connected to the input terminal N1 of the memory circuit 25.

When a high-level image signal is input to the input terminal N1 of the memory circuit 25, the memory circuit 25 outputs the low-potential supply potential Vss from the output terminal N2 thereof, and when a low-level image signal is input to the input terminal N1, the memory circuit 25 outputs the high-potential supply potential VEP from the output terminal N2. That is, the memory circuit 25 outputs the low-potential supply potential Vss or the high-potential supply potential VEP depending on whether an input image signal is at high level or at low level. In other words, the memory circuit 25 is configured to be able to store an input image signal as the low-potential supply potential Vss or the high-potential supply potential VEP.

The switch circuit 110 is provided with a first transmission gate 111 and a second transmission gate 112.

The first transmission gate 111 is provided with a P-type transistor 111p and an N-type transistor 111n. The sources of the P-type transistor 111p and the N-type transistor 111n are electrically connected to the first control line 94. The drains of the P-type transistor 111p and the N-type transistor 111n are electrically connected to the pixel electrode 21. The gate of the P-type transistor 111p is electrically connected to the input terminal N1 of the memory circuit 25, and the gate of the N-type transistor 111n is electrically connected to the output terminal N2 of the memory circuit 25.

The second transmission gate 112 is provided with a P-type transistor 112p and an N-type transistor 112n. The sources of the P-type transistor 112p and the N-type transistor 112n are electrically connected to the second control line 95. The drains of the P-type transistor 112p and the N-type transistor 112n are electrically connected to the pixel electrode 21. The gate of the P-type transistor 112p is electrically connected to the output terminal N2 of the memory circuit 25. The gate of the N-type transistor 112n is electrically connected to the input terminal N1 of the memory circuit 25.

The switch circuit 110 selects one of the first control line 94 and the second control line 95 in response to an image signal input to the memory circuit 25 and electrically connects the control line to the pixel electrode 21.

Specifically, when a high-level image signal is input to the input terminal N1 of the memory circuit 25, the low-potential supply potential Vss is output from the memory circuit 25 to the gates of the N-type transistor 111n and the P-type transistor 112p, and the high-potential supply potential VEP is output to the gates of the P-type transistor 111p and the N-type transistor 112n, so that only the P-type transistor 112p and the N-type transistor 112n that constitute the second transmission gate 112 are turned on, and the P-type transistor 111p and the N-type transistor 111n that constitute the first transmission gate 111 are turned off. On the other hand, when a low-level image signal is input to the input terminal N1 of the memory circuit 25, the high-potential supply potential VEP is output from the memory circuit 25 to the gates of the N-type transistor 111n and the P-type transistor 112p, and the low-potential supply potential Vss is output to the gates of the P-type transistor 111p and the N-type transistor 112n, so that only the P-type transistor 111p and the N-type transistor 111n that constitute the first transmission gate 111 are turned on, and the P-type transistor 112p and the N-type transistor 112n that constitute the second transmission gate 112 are turned off. That is, when a high-level image signal is input to the input terminal N1 of the memory circuit 25, only the second transmission gate 112 is turned on; on the other hand, when a low-level image signal is input to the input terminal N1 of the memory circuit 25, only the first transmission gate 111 is turned on.

The individual pixel electrodes 21 of the plurality of pixels 20 are electrically connected to the first control line 94 or the second control line 95 that is selected by the switch circuit 110 in response to an image signal. At that time, the individual pixel electrodes 21 of the pixels 20 receive the first potential S1 or the second potential S2 or are brought into a high impedance state depending on the ON/OFF state of the switch 94s or 95s.

More specifically, for the pixels 20 to which a low-level image signal is supplied, only the first transmission gates 111 are turned on, and the pixel electrodes 21 of the pixels 20 are electrically connected to the first control line 94 and are supplied with the first potential S1 from the power supply circuit 200 or are brought into a high impedance state depending on the ON/OFF state of the switch 94s; on the other hand, for the pixels 20 to which a high-level image signal is supplied, only the second transmission gates 112 are turned on, and the pixel electrodes 21 of the pixels 20 are electrically connected to the second control line 95 and are supplied with the second potential S2 from the power supply circuit 200 or are brought into a high impedance state depending on the ON/OFF state of the switch 95s.

The pixel electrode 21 is disposed so as to face the common electrode 22 with the electrophoretic element 23 therebetween. The common electrode 22 is electrically connected to the common potential line 93 to which the common potential Vcom is supplied.

The electrophoretic element 23 is constituted of a plurality of microcapsules 80 each containing electrophoretic particles.

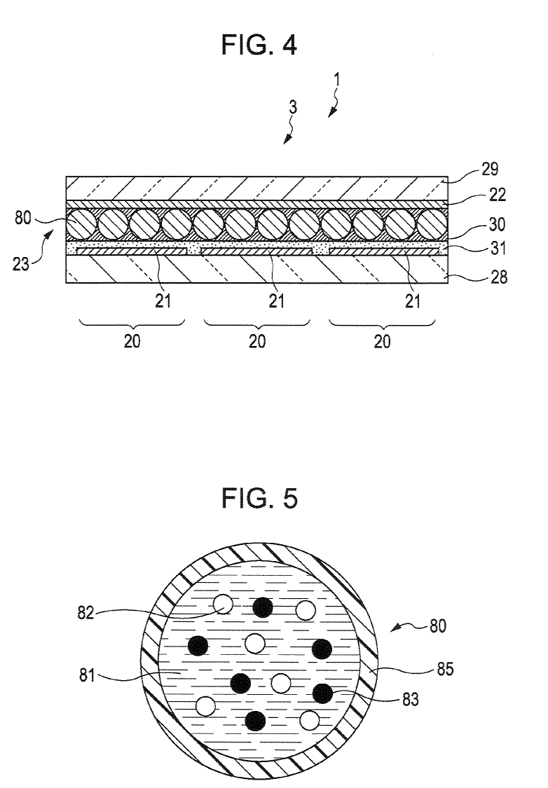

Next, the concrete configuration of the display of the electrophoretic display apparatus according to this embodiment will be described with reference to FIGS. 4 and 5.

FIG. 4 is a fragmentary cross-sectional view of the display of the electrophoretic display apparatus according to this embodiment.

In FIG. 4, the display 3 is configured such that the electrophoretic element 23 is sandwiched between a device substrate 28 and a counter substrate 29. This embodiment is described on the assumption that an image is displayed on the counter substrate 29.

The device substrate 28 is a substrate made of glass or plastic, for example. The device substrate 28 has thereon a layered structure of the pixel switching transistor 24, the memory circuit 25, the switch circuit 110, the scanning lines 40, the data lines 50, the high-potential power supply line 91, the low-potential power line 92, the common potential line 93, the first control line 94, the second control line 95, etc. The plurality of pixel electrodes 21 are provided in matrix form on the upper layer of the layered structure.

The counter substrate 29 is a transparent substrate formed of glass or plastic, for example. The common electrode 22 is solidly formed on the surface of the counter substrate 29 facing the device substrate 28 so as to face the plurality of pixel electrodes 9a. The common electrode 22 is formed of a transparent conducting material, such as magnesium-silver (MgAg), indium tin oxide (ITO), or indium zinc oxide (IZO).

The electrophoretic element 23 is constituted of the plurality of microcapsules 80 each containing electrophoretic particles and is fixed between the device substrate 28 and the counter substrate 29 with a binder 30 and an adhesive layer 31 made of resin or the like. The electrophoretic display panel 1 according to this embodiment is manufactured such that the electrophoretic sheet, in which the electrophoretic element 23 is fixed to the counter substrate 29 with the binder 30 in advance, is bonded to the device substrate 28, which is separately manufactured and on which the pixel electrodes 21 etc. are formed, with the adhesive layer 31.

The microcapsules 80 are sandwiched between the pixel electrode 21 and the common electrode 22 and one or a plurality of microcapsules 80 is disposed in one pixel 20 (in other words, for one pixel electrode 21).

FIG. 5 is a schematic diagram showing the configuration of the microcapsule 80. FIG. 5 schematically shows a cross section of the microcapsule 80.

Referring to FIG. 5, the microcapsule 80 contains a dispersion medium 81, a plurality of white particles 82, and a plurality of black particles 83 inside a coating 85. The microcapsule 80 has a spherical shape with a diameter of about 50 um, for example. The white particles 82 and the black particles 83 are examples of electrophoretic particles according the invention.

The coating 85 functions as the outer shell of the microcapsule 80 and is formed of transparent polymeric resin such as acrylic resin, that is, polymethyl methacrylate or polyethyl methacrylate, urea resin, or gum arabic.

The dispersion medium 81 is a medium in which the white particles 82 and the black particles 83 are dispersed in the microcapsule 80 (in other words, in the coating 85). Examples of the dispersion medium 81 are water; alcohol solvents such as methanol, ethanol, isopropanol, butanol, octanol, and methylcellulose; esters such as ethyl acetate and butyl acetate; ketones such as acetone, methyl ethyl ketone, and methyl isobutyl ketone; aliphatic hydrocarbons such as pentane, hexane, and octane; alicyclic hydrocarbons such as cyclohexane and methylcyclohexane; aromatic hydrocarbons such as benzenes having a long chain alkyl group, such as benzene, toluene, xylene, hexylbenzene, hebutylbenzene, octylbenzen, nonylbenzene, decylbenzene, undecylbenzene, dodecylbenzene, tridecylbenzene, and tetradecylbenzene; halogenated hydrocarbon such as methylene chloride, chloroform, carbon tetrachloride, 1,2-dichloroethane, carboxylic acid, and other oils, which may be used alone or in combination. The dispersion medium 81 may contain a surface-active agent.

The white particles 82 are particles (high polymer or colloid) made of white pigments, such as titanium dioxide, flowers of zinc (zinc oxide), or antimony trioxide, and are negatively charged, for example.

The black particles 83 are particles (high polymer or colloid) made of black pigments, such as, aniline black or carbon black, and are positively charged, for example.

Therefore, the white particles 82 and the black particles 83 can move in the dispersion medium 81 due to an electric field generated due to the potential difference between the pixel electrodes 21 and the common electrode 22.

These pigments may be mixed with a charge control agent formed of particles of an electrolyte, a surface-active agent, metallic soap, resin, rubber, oil, varnish, or a compound, a dispersion agent such as a titanium coupling agent, an aluminum coupling agent, or a silane coupling agent, a lubricant, or a stabilizing agent as necessary.

Referring to FIGS. 4 and 5, when voltage is applied between the pixel electrodes 21 and the common electrode 22 so that the potential of the common electrode 22 becomes relatively high, the positively charged black particles 83 are attracted toward the pixel electrodes 21 in the microcapsule 80 by Coulomb force, and the negatively charged white particles 82 are attracted toward the common electrode 22 in the microcapsule 80 by Coulomb force. As a result, the white particles 82 gather to the display surface side (that is, to the common electrode 22) in the microcapsule 80, so that the color (that is, white) of the white particles 82 can be displayed on the display surface of the display 3. In contrast, when voltage is applied between the pixel electrodes 21 and the common electrode 22 so that the potential of the pixel electrodes 21 becomes relatively high, the negatively charged white particles 82 are attracted toward the pixel electrodes 21 by Coulomb force, and the positively charged black particles 83 are attracted toward the common electrode 22 by Coulomb force. As a result, the black particles 83 gather to the display surface side in the microcapsule 80, so that the color (that is, black) of the black particles 83 can be displayed on the display surface of the display 3.

Gray, which is a halftone between white and black, such as light gray, gray, or dark gray, can be displayed in accordance with the dispersion state of the white particles 82 and the black particles 83 between the pixel electrodes 21 and the common electrode 22. Red, green, blue, etc. can also be displayed by replacing the pigments used for the white particles 82 and the black particles 83 with pigments, for example, red, green, and blue.

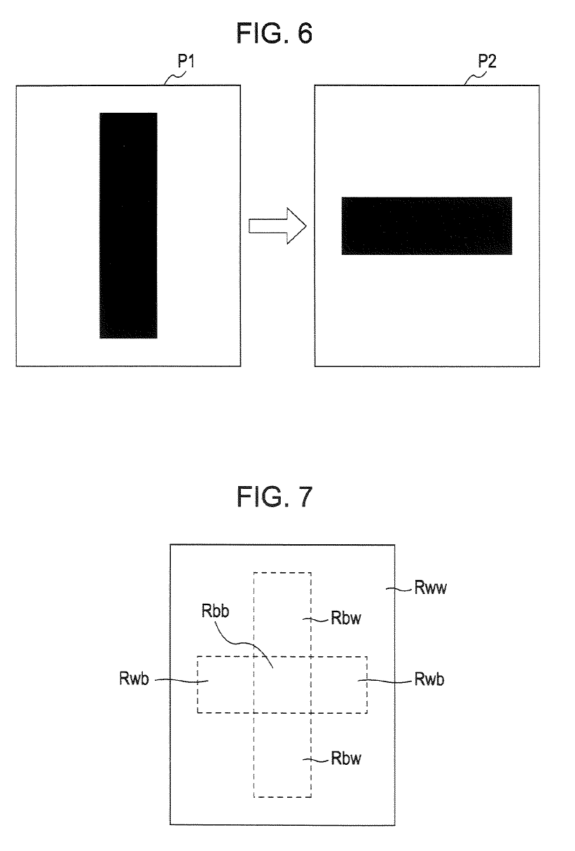

Next, the operation of the above-described electrophoretic display apparatus 1 will be described with reference to FIGS. 6 to 8. First, “partial rewrite driving” in which an image displayed on the display 3 is partially rewritten by applying voltage between the pixel electrodes 21 and the common electrode 22 of only part of the pixels 20 of the display 3 is first described, and then control of power supply circuit 200 by the controller 10 according to a rewritten area during the “partial rewrite driving” will be described.

FIG. 6 is a plan view showing an example of images before and after rewriting.

As shown in FIG. 6, a case in which an image displayed on the display 3 is rewritten from an image P1 shown at the left of the drawing to an image P2 shown at the right of the drawing will be described by way of example. That is, a case in which a vertical black belt drawn on a white background changes to a lateral belt is shown as an example.

FIG. 7 is a plan view showing images by conceptual region according to the gray levels before and after rewriting.

Referring to FIG. 7, the image displayed on the display 3 can be divided into four regions according to the individual gray levels before and after rewriting; specifically, a region Rwb constituted of pixels 20 that display white in the image P1 before rewriting (see FIG. 6) and display black in the image P2 after rewriting, a region Rww constituted of pixels 20 that display white in the image P1 before rewriting and display white in the image P2 after rewriting, a region Rbw constituted of pixels 20 that display black in the image P1 before rewriting and display white in the image P2 after rewriting, and a region Rbb constituted of pixels 20 that display black in the image P1 before rewriting and display black in the image P2 after rewriting.

This embodiment adopts “partial rewrite driving”, in which the rewriting of an image is executed through two partial rewriting steps, that is, a first partial rewriting step and a second partial rewriting step.

In the first partial rewriting step, a predetermined drive voltage (for example, 12 V) is applied between the pixel electrodes 21 and the common electrode 22 of only the pixels 20 to be rewritten from black to white (that is, the pixels 20 in the region Rbw).

Specifically, in the first partial rewriting step, the common potential Vcom is applied, as the first potential S1, to the pixel electrodes 21 corresponding to the region Rww, the region Rwb, and the region Rbb. That is, the common potential Vcom output from the power supply circuit 200 is supplied through the first control line 94. Accordingly, a potential difference between the pixel electrodes 21 and the common electrode 22 is not generated in the pixels 20 in the region Rww, the region Rwb, and the region Rbb (that is, no drive voltage is applied between the pixel electrodes 21 and the common electrode 22). Accordingly, the gray level of the pixels 20 are maintained. On the other hand, for the pixel electrodes 21 corresponding to the region Rbw, the low potential VL is applied as the second potential S2. That is, the low potential VL output from the power supply circuit 200 is supplied through the second control line 95. The low potential VL (for example, 0 V) corresponds to white (that is, because, between the pixel electrodes 21, which are brought to the low potential VL, and the common electrode 22, which is brought to the high potential VH due to the application of the common potential Vcom, the white particles 82, which are, for example, negatively charged, move toward the common electrode 22, and the black particles 83, which are, for example, positively charged, move toward the pixel electrodes 21), the gray level of the pixels 20 in the region Rbw is rewritten from black to white.

In the second partial rewriting step following the first partial rewriting step, a predetermined drive voltage (for example, 12 V) is applied between the pixel electrodes 21 and the common electrode 22 in only the pixels 20 to be rewritten from white to black (that is, the pixels 20 in the region Rwb).

Specifically, in the second partial rewriting step, the common potential Vcom is supplied, as the first potential S1, to the pixel electrodes 21 corresponding to the region Rww, the region Rbw, and the region Rbb. That is, the common potential Vcom output from the power supply circuit 200 is supplied through the first control line 94. Accordingly, a potential difference between the pixel electrodes 21 and the common electrode 22 is not generated in the pixels 20 in the region Rww, the region Rbw, and the region Rbb (that is, no drive voltage is applied between the pixel electrodes 21 and the common electrode 22). Accordingly, the gray level of the pixels 20 are maintained. On the other hand, for the pixel electrode 21 corresponding to the region Rwb, the high potential VH is supplied as the second potential S2. That is, the high potential VH output from the power supply circuit 200 is supplied through the second control line 95. The high potential VH (for example, 12 V) corresponds to black (that is, because, between the pixel electrodes 21, which are brought to the high potential VH, and the common electrode 22, which is brought to the low potential due to the application of the common potential Vcom, the black particles 83, which are, for example, positively charged, move toward the common electrode 22, and the white particles 82, which are, for example, negatively charged, move toward the pixel electrodes 21), the gray level of the pixels 20 in the region Rwb is rewritten from white to black.

In this way, the image P1 is rewritten to the image P2 in two steps.

In the individual partial rewriting steps, driving power necessary for applying drive voltage between the pixel electrodes 21 and the common electrode 22 changes depending on the area of the region to be rewritten (for example, the region Rbw in the first partial rewriting step and the region Rwb in the second partial rewriting step). That is, a total current that flows between the pixel electrodes 21 and the common electrode 22 of the pixels 20 in the region to be rewritten changes depending on the area of the region to be rewritten (hereinafter appropriately referred to as “rewritten area”), a load on the electrophoretic display apparatus 1 changes. That is, for example, the larger the rewritten area, the higher the load on the electrophoretic display apparatus 1 is, and the smaller the rewritten area, the lower the load on the electrophoretic display apparatus 1 is.

Accordingly, in this embodiment, in particular, the controller 10 controls the power supply circuit 200 in accordance with the rewritten area. [00106] Referring again to FIG. 2, the controller 10 has the rewritten-area calculating unit 12. The rewritten-area calculating unit 12 calculates a rewritten area on the basis of image data stored in the memory 11.

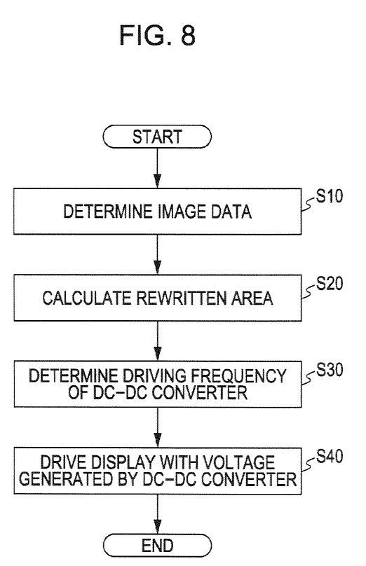

FIG. 8 is a flowchart showing a method for controlling the power supply circuit 200 by the controller 10 in this embodiment.

As described above with reference to FIG. 6, the case in which an image displayed on the display 3 is rewritten from the image P1 shown at the left of the drawing to the image P2 shown at the right of the drawing will be described hereinbelow by way of example.

Referring to FIG. 8, first, image data is determined (step S10). That is, in a state in which the image P1 is displayed, image data on the image P2 is determined as an image to be newly displayed is determined by the controller 100.

Next, a rewritten area is calculated by the rewritten-area calculating unit 12 (step S20). That is, the rewritten-area calculating unit 12 specifies a region to be rewritten (referring to FIG. 7, for example, the above-described region Rbw or Rwb) on the basis of the image data on the image P1 and the image data on the image P2 and calculates the area of the specified region (that is, rewritten area).

Next, the driving frequency of the DC-DC converter 230 is determined (step S30). That is, the controller 10 determines the drive frequency of the DC-DC converter 230 on the basis of a lookup table in which rewritten areas and the drive frequencies of the DC-DC converter 230 are associated with each other. At that time, the controller 10 determines the drive frequency of the DC-DC converter 230 so as to become lower as the rewritten area decreases. Furthermore, the controller 10 controls the oscillator circuit 240 so as to output a clock signal having the determined drive frequency. In other words, the controller 10 controls the DC-DC converter 230 so that it operates at a lower drive frequency as the rewritten area decreases by controlling the oscillator circuit 240 so that the smaller the rewritten area, the lower the frequency of the clock signal becomes. Accordingly, the power supply capacity of the DC-DC converter 230 can be reduced as the rewritten area is decreased (in other words, the power supply capacity of the DC-DC converter 230 can be increased as the rewritten area increases).

Next, the display 3 is driven with a voltage generated by the DC-DC converter 230 that operates at the drive frequency according to the rewritten area (step S40). That is, a drive voltage based on the high potential VH generated by the DC-DC converter 230 that operates at the drive frequency according to the rewritten area is applied between the pixel electrodes 21 and the common electrode 22 of the pixels 20 in the region to be rewritten, so that the image in the region to be rewritten is rewritten.

In this embodiment, in particular, as described above, the controller 10 controls the DC-DC converter 230 so that it operates at a lower drive frequency as the rewritten area decreases by controlling the oscillator circuit 240 so that the smaller the rewritten area, the lower the frequency of the clock signal becomes. Accordingly, the power consumed by the switching operation of the switches SW1a, SW1b, SW1c, SW2a, SW2b, SW2c, SW3a, SW3b, SW3c, and SW4a of the DC-DC converter 230 can be reduced more as compared with, for example, a case in which the drive frequency of the DC-DC converter 230 is constant at a predetermined frequency (that is, a drive frequency needed when the rewritten area is the maximum) irrespective of the rewritten area. Furthermore, since the DC-DC converter 230 is controlled according to the rewritten area, the power consumed by the power supply circuit 200 can be decreased more as compared with the configuration in which the power supply circuit 200 includes the monitor circuit that monitors the output voltage of the DC-DC converter 230. Accordingly, the power consumed when an image displayed on the display 3 is rewritten can be reduced. In addition, since power according to the rewritten area is supplied from the power supply circuit 200 to the display 3, a drive voltage (for example, 12 V) can be reliably applied between the pixel electrodes 21 and the common electrode 22 of the pixels 20 to be rewritten. This allows a high-quality image to be displayed.

As described above, with the electrophoretic display apparatus 1 according to this embodiment, the controller 10 controls the DC-DC converter 230 so that it operates at a lower drive frequency as the rewritten area decreases by controlling the oscillator circuit 240 so that the smaller the rewritten area, the lower the frequency of the clock signal becomes, thus allowing a high-quality image to be displayed while reducing power consumption.

### Electronic Apparatus

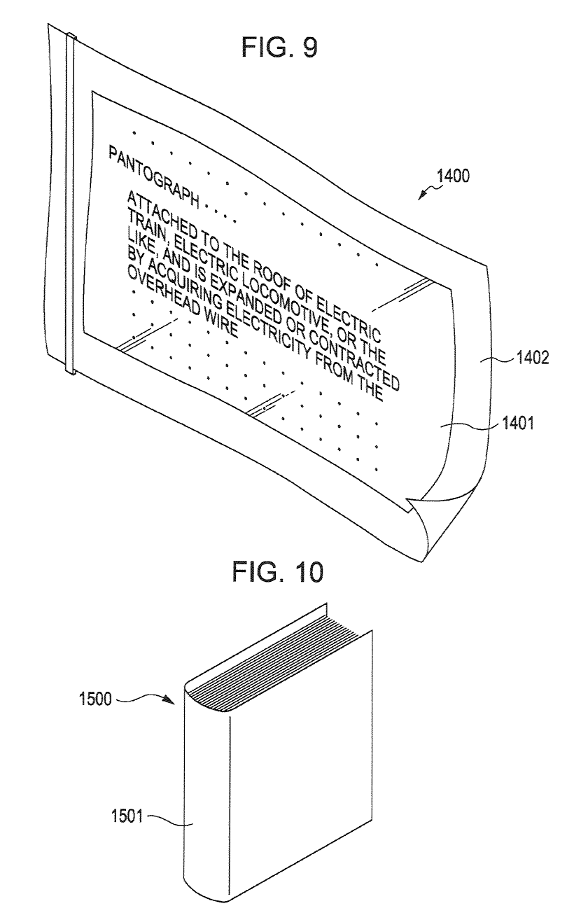

Next, electronic apparatuses incorporating the above-described electrophoretic display apparatus will be described with reference to FIGS. 9 and 10. Here, a case in which the above electrophoretic display apparatus is applied to an electronic paper and an electronic notebook will be described by way of example.

FIG. 9 is a perspective view showing the configuration of an electronic paper 1400.

As shown in FIG. 9, the electronic paper 1400 is equipped with the electrophoretic display apparatus according to the foregoing embodiment as a display 1401. The electronic paper 1400 has flexibility and is provided with a main body 1402 formed of a rewritable sheet having the same texture and softness as traditional paper.

FIG. 10 is a perspective view showing the configuration of an electronic notebook 1500.

As shown in FIG. 10, the electronic notebook 1500 is configured such that a plurality of the electronic paper 1400 shown in FIG. 9 are bound and held by a cover 1501. The cover 1501 is provided with display-data input means (not shown) for inputting display data sent from an external device, for example. Thus, display content can be changed or updated in accordance with the display data, with the electronic paper bound.

Since the above-described electronic paper 1400 and electronic notebook 1500 are equipped with the electrophoretic display apparatus according to the foregoing embodiment, they can display a high-quality image while reducing power consumption.

In addition to those, the electrophoretic display apparatus according to the above embodiment can be applied the displays of electronic apparatuses such as wristwatches, mobile phones, and portable audio devices.

It is to be understood that the invention is not limited to the above-described embodiment and that various modifications can be made without departing from the scope and spirit of the invention as set out in the accompanying claims and the specification; any electrophoretic display apparatuses subjected to such modifications and electronic apparatuses equipped with such electrophoretic display apparatuses are also within the technical scope of the invention.

The entire disclosure of Japanese Patent Application No. 2008-150259, filed Jun. 9, 2008 is expressly incorporated by reference herein.

What is claimed is:

1. An electrophoretic display apparatus comprising:
a display including a plurality of pixels each having a pixel electrode;
a common electrode opposed to the pixel electrode;
an electrophoretic element disposed between the pixel electrode and the common electrode, the electrophoretic element containing electrophoretic particles;
a driving unit that performs partial rewrite driving to partially rewrite an image displayed on the display by applying a drive voltage between the pixel electrode and the common electrode in part of the plurality of pixels on the basis of image data;
a power supply circuit that increases power supply voltage and supplies the drive voltage to the driving unit; and
a control unit that controls the power supply circuit so as to change the drive-voltage supply capacity of the power supply circuit in accordance with the area of a rewritten region that the part of the pixels occupies in the display.

2. The electrophoretic display apparatus according to claim 1, wherein the control unit controls the power supply circuit so that the drive-voltage supply capacity is decreased as the area of the rewritten region decreases.

3. The electrophoretic display apparatus according to claim 1, wherein the control unit includes a calculating unit that calculates the area of the rewritten region on the basis of the image data.

4. The electrophoretic display apparatus according to claim 1, wherein
the power supply circuit includes:
an oscillator circuit that outputs a clock signal by performing an oscillating operation; and
a booster circuit that increases the power supply voltage to the drive voltage by performing a charging pump operation according to the clock signal, wherein
the control unit controls the oscillator circuit so that the frequency of the clock signal is decreased as the area of the rewritten region decreases.

5. An electronic apparatus comprising the electrophoretic display apparatus according to claim 1.
